(19) United States
(12) Patent Application Publication
(10) Pub. No.: US 2012/0103954 A1
(43) Pub. Date: May 3, 2012

(54) SYSTEM AND METHOD FOR MINIMIZING FORMATION OF STRIATION PATTERNS IN LASER CUTTING

(75) Inventors: BEKIR S. YILBAS, DHAHRAN (SA); MUHAMMAD A. HAWWA, DHAHRAN (SA)

(73) Assignee: KING FAHD UNIVERSITY OF PETROLEUM AND MINERALS, DHAHRAN (SA)

(21) Appl. No.: 12/917,278

(22) Filed: Nov. 1, 2010

(51) Int. Cl. B23K 26/38

(52) U.S. Cl. 219/121.72; 219/121.67

(57) ABSTRACT

The system and method for minimizing formation of striation patterns in laser cutting provides real-time monitoring and control of laser cutting quality. Laser cutting of a workpiece is controlled through monitoring of thermal radiation generation, particularly during a laser gas-assisted cutting process. The apparatus includes an optical probe positioned adjacent the impingement point of the laser beam on the workpiece. The optical probe is in communication with a signal analyzer for measuring electrical voltage generated by thermal radiation generated by the cutting of the workpiece. A controller is provided for comparing the measured electrical voltage with a desired threshold voltage. Control signals are generated to selectively adjust output frequency of the laser responsive to the compared measured electrical voltage and the desired threshold voltage to minimize striation pattern generation.

### BACKGROUND OF THE INVENTION

1. Field of the Invention

The present invention relates to laser cutting, and particularly to a system and method for minimizing the formation of striation patterns in laser cutting during laser gas-assisted cutting.

2. Description of the Related Art

Laser cutting is a technology that uses a laser to cut materials, and is typically used for industrial manufacturing applications. Laser cutting is performed by directing the output of a high power laser, by computer, at the material to be cut. The material then either melts, burns, vaporizes away, or is blown away by a jet of gas, leaving an edge with a high quality surface finish. Industrial laser cutters are used to cut flat-sheet material as well as structural and piping materials.

Laser cutting of metals is used in wide applications in various industries due to its precise operation. However, one of the primary defects that reduces the quality of the laser cutting is the formation of striation patterns along the cut edges (as illustrated in FIG. 2). The formation of these striations is even more pronounced during the cutting of metallic materials under an assisting gas. It is believed that striation patterns are formed due to the excessive heat generation in the kerf during the cutting process. This phenomenon is generally referred to as “thermal erosion”. Heat generated during the laser cutting process causes excessive thermal radiation in the cutting section. The thermal radiation intensity is typically monitored by an adjacent fiber optic cable 1 04, as illustrated in FIG. 3.

The representative prior art system 100 of FIG. 3 includes a laser L that is mounted above the workpiece W to be cut. The laser L produces a beam B, which is focused by a focusing lens FL held within a holder H. For gas-assisted laser cutting, an assisting gas G, such as nitrogen, is fed under pressure into the hollow holder H via a line 102, and the assisting gas G is sprayed simultaneously and coaxially with the focused laser beam B cutting the workpiece W. The formation of cut edges E during the cutting process is monitored by a fiber optic probe 104. A cable 106 leads from the probe 104 to detection and analysis circuitry (not shown). Specifically, the fiber optic probe 104 picks up the thermal radiation formed during the cutting of the workpiece W. The fiber optic probe 104 may include an extension tube 108, as is conventionally known. In FIG. 3, cut edges E are formed with striation patterns, similar to those shown in the electron micrograph of FIG. 2.

Since the laser cutting that forms edges E remains at high temperatures (i.e., above the melting temperature of the substrate material), monitoring of the thermal radiation must be performed carefully. The optical fiber cable should be positioned at a safe distance from the irradiated spot while it captures the emitted thermal radiation from the irradiated surface.

In the paper Yilbas B. S., Nickel J. and Coban A., “Effect of oxygen in laser cutting process”, Material and Manufacturing Processes, Vol. 12, No. 6, pp. 1163-1175 (1997), it was shown that measured signals of the optical fiber probe are highly correlated with the roughness of the cut edge surface. It should be noted that the roughness of the cut edge surface is mainly due to the striation pattern, as shown in FIG. 4. In FIG. 4, the upper plot illustrates measured surface roughness of the laser cut edge (measured in micrometers). The lower oscilloscope output shows the optical fiber probe output (measured in volts). FIG. 4 compares the temporal variation of surface roughness of the laser cut edges and the corresponding optical fiber measured signals due to detection of thermal radiation (amplified through the associated electronics). The typical velocity of the laser beam (or, alternatively, of the workpiece W moving relative to a fixed laser L) is between 20 and 60 cm/s.

With this correlation in mind, it would be desirable to be able to tune the laser beam in order to minimize the striation pattern during laser cutting. Thus, a system and method for minimizing the formation of striation patterns in laser cutting solving the aforementioned problems is desired.

### SUMMARY OF THE INVENTION

The system and method for minimizing formation of striation patterns in laser cutting provides real-time monitoring and control of laser cutting quality. Laser cutting of a workpiece, such as a thin metallic sheet, is controlled through the monitoring of thermal radiation generated during the laser cutting, particularly during a laser gas-assisted cutting process.

Laser cutting includes a laser for selectively generating a laser beam, along with one or more lenses for focusing the laser beam onto a surface of a workpiece in order to cut the workpiece at a focal point. The system for controlling the cutting includes a fiber optic probe or the like, which is positioned adjacent the focal point. The fiber optic probe is in communication with a signal analyzer for measuring electrical voltage generated in the fiber optic probe representative of thermal radiation generated at the surface of the workpiece during the cutting of the workpiece with the laser beam.

A controller is provided for estimating the root mean square (rms) value of the measured optical fiber probe signals, and for tuning the laser beam frequency until a desired threshold rms value is attained. The controller specifically calculates an error value as the difference between the measured rms value and the threshold rms value. The controller transmits this error value to a laser controller, which generates a tuning signal, which is transmitted to an actuator associated with the laser. The actuator adjusts the laser beam frequency until the error value is minimized, thus minimizing the generation of striation patterns during cutting in real time. Optimal minimization of striations occurs when the error value is zero; i.e., when the desired threshold rms is equal to the calculated rms of the probe-measured signal spectrum.

These and other features of the present invention will become readily apparent upon further review of the following specification and drawings.

### BRIEF DESCRIPTION OF THE DRAWINGS

FIG. 1 is a block diagram providing an overview of a system for minimizing the formation of striation patterns in laser cutting according to the present invention.

FIG. 2 is an electron micrograph illustrating striation patterns formed in a thin metallic workpiece during laser cutting using conventional cutting methods.

FIG. 3 is a schematic diagram of a conventional prior art laser cutting system with thermal radiation monitoring.

FIG. 4 is a waveform diagram providing a comparison between temporal variation of surface roughness of a laser cut edge and corresponding optical fiber measured signals due to detection of thermal radiation, such as those generated by the prior art system of FIG. 3.

FIG. 5 is a block diagram of a controller associated with the system for minimizing the formation of striation patterns in laser cutting of FIG. 1.

Similar reference characters denote corresponding features consistently throughout the attached drawings.

### DETAILED DESCRIPTION OF THE PREFERRED EMBODIMENTS

The system and method for minimizing the formation of striation patterns in laser cutting provides real-time monitoring and control of laser cutting quality. Laser cutting of a workpiece W, such as a thin metallic sheet, is controlled through the monitoring of thermal radiation generated during the laser cutting, particularly during a laser gas-assisted cutting process.

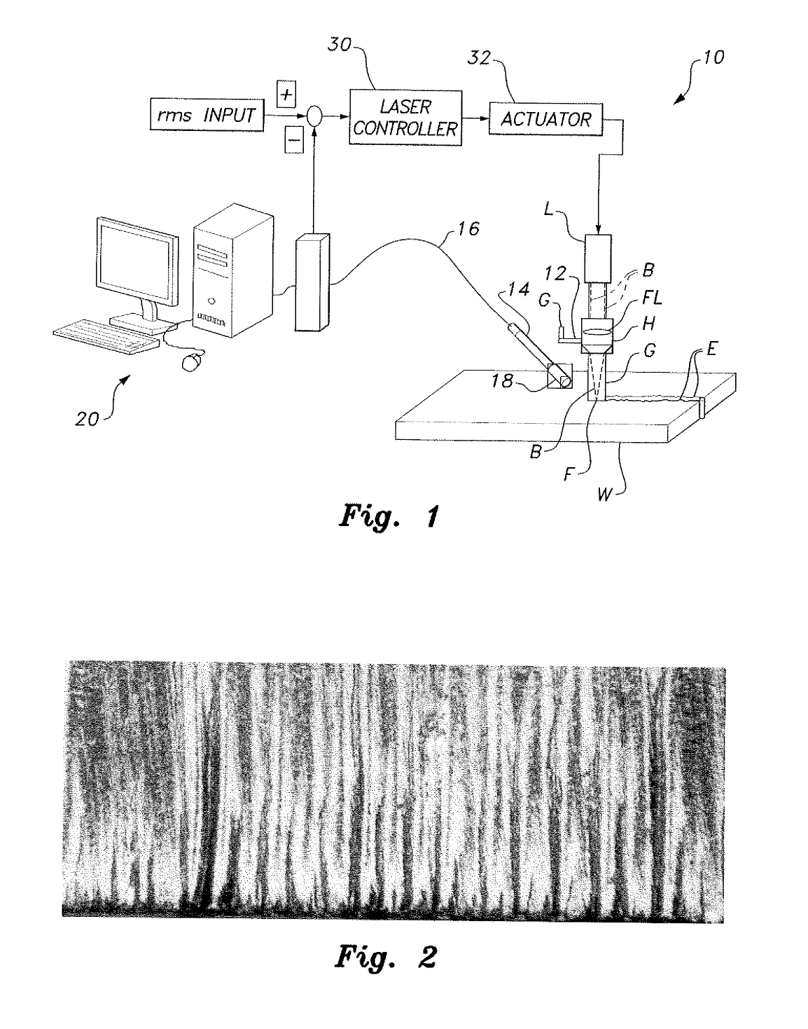

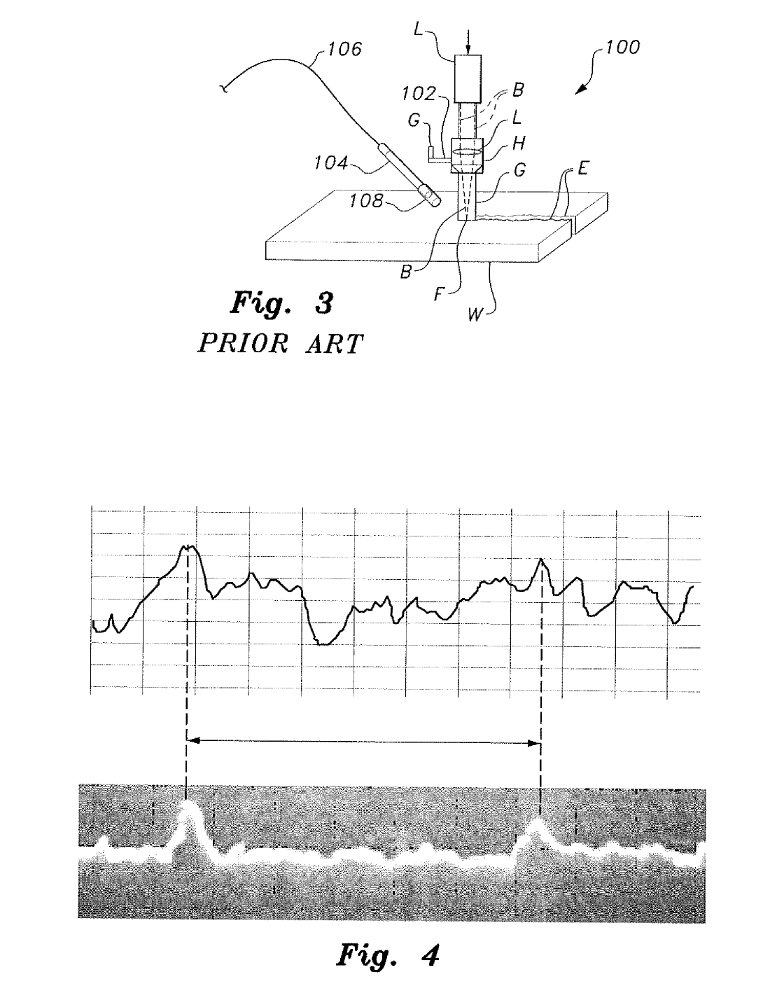

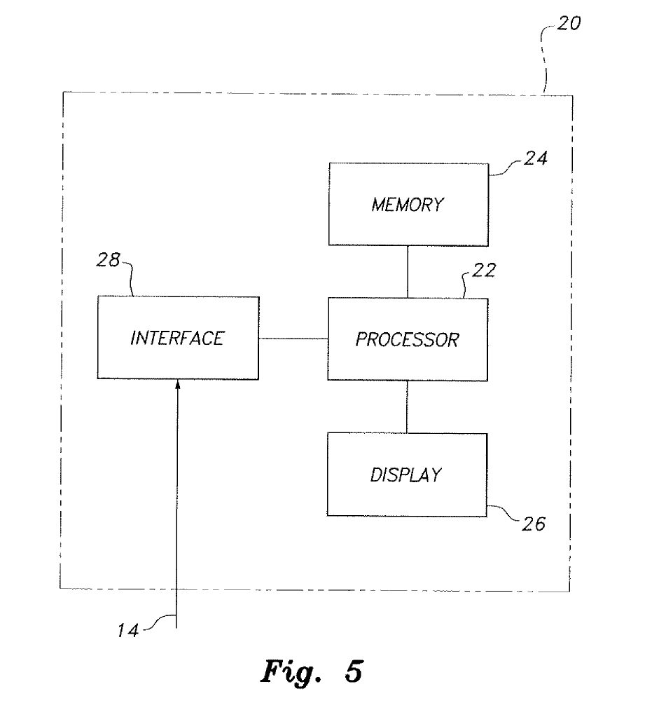

FIG. 1 diagrammatically illustrates the laser cutting process. The laser cutting system 10 includes a laser L for selectively generating a laser beam B, along with one or more focusing lenses FL for focusing the laser beam B onto a surface of a workpiece W in order to cut the workpiece W at a focal point. It should be understood that the laser L may be any suitable type of tunable laser with sufficient frequency range and intensity to cut a thin metallic workpiece W.

The focusing lens or lenses FL may be any suitable type of convex lenses or any other suitable type of focusing elements capable of focusing the laser beam B into a cutting focal point F for forming cut edges E in the workpiece W. The laser L may be mounted above the workpiece W by any suitable type of movable mount for moving beam the B across the workpiece W. Alternatively, the workpiece W may be mounted on any suitable type of movable platform, such as a conventional X-Y stage, allowing the workpiece W to be moved with respect to the focal point F. The lens(es) FL may be mounted within any suitable type of holder H which is preferably hollow, allowing an assisting gas G, such as nitrogen or the like, to flow therethrough. As shown in FIG. 1, the gas G flows under pressure into the holder H through line 12 so that the gas G is sprayed simultaneously and coaxially with the focused laser beam B cutting the workpiece W, as is well known in gas-assisted laser cutting.

The formation of cut edges E during the cutting process is monitored by a fiber optic probe 14. A cable 16 leads from the probe 14 to a controller 20. Specifically, the fiber optic probe 14 measures the thermal radiation formed during the cutting of the workpiece W and generates a corresponding electrical signal representative of the generated thermal radiation. The fiber optic probe 14 may be any suitable type of fiber optic probe, which are well known in the art, or any other suitable type of optical probe capable of operating in the infrared range, which may include the near-infrared, mid-wavelength infrared (MWIR). or long-wavelength infrared (LWIR) ranges. The fiber optic probe 14 may be of the single core optical fiber type, and the probe end may be embedded within an extended tube 18, as is well known, with the extended tube 18 having the same diameter as the fiber cable for limiting thermal radiation emanating from the other regions of the cut section.

The probe end is positioned adjacent the focal point F, as shown. The fiber optic probe is in communication with the controller 20, which acts as a signal analyzer, for measuring electrical voltage generated in the fiber optic probe 14, which is representative of thermal radiation generated at the surface of the workpiece W during the cutting of the workpiece W with the laser beam B.

The controller 20 is provided for estimating the root mean square (rms) value of the measured optical fiber probe signals, and for tuning the laser beam frequency until a desired threshold rms value is attained. The controller 20 specifically calculates an error value as the difference between the measured rms value and the desired threshold rms value. The controller 20 transmits this error value to a laser controller 30, which generates a tuning signal, which is transmitted to an actuator 32 associated with the laser L Laser controller 30 may be any suitable type of controller and may be integrated into controller 20. Similarly, actuator 32 may be any suitable type of actuator capable of generating and transmitting frequency control signals, and may be integrated into the laser controller 30 or the controller 20.

The actuator 32 adjusts the laser beam frequency until the error value is minimized, thus minimizing the generation of striation patterns during cutting in real time. Optimal minimization of striations occurs when the error value is zero; i.e., when the threshold rms is equal to the calculated rms of the laser measured signal spectrum.

It should be understood that the calculations may be performed by any suitable computer system or controller, such as that diagrammatically shown in FIG. 5. Data is entered into the controller 20 by any suitable type of user interface 28, along with the input signal generated by the probe 14, and may be stored in memory 24, which may be any suitable type of computer readable and programmable memory. Calculations are performed by a processor 22, which may be any suitable type of computer processor, microprocessor, microcontroller, digital signal processor, or the like, and may be displayed to the user on display 26, which may be any suitable type of computer display.

Processor 22 may be associated with, or incorporated into, any suitable type of computing device, for example, a personal computer or a programmable logic controller. The display 26, the processor 22, the memory 24 and any associated computer readable recording media are in communication with one another by any suitable type of data bus, as is well known in the art.

Examples of computer-readable recording media include a magnetic recording apparatus, an optical disk, a magneto-optical disk, and/or a semiconductor memory (for example, RAM, ROM, etc.). Examples of magnetic recording apparatus that may be used in addition to memory 24, or in place of memory 24, include a hard disk device (HOD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

It is to be understood that the present invention is not limited to the embodiments described above, but encompasses any and all embodiments within the scope of the following claims.

We claim:

1. A method for minimizing formation of striation patterns in laser cutting, comprising the steps of:
positioning an optical probe adjacent a focal point of a laser beam on a workpiece being cut by the laser beam;
measuring electrical voltage generated in the optical probe from detection of thermal radiation generated during the cutting of the workpiece by the laser beam;
comparing the measured electrical voltage with a desired threshold voltage; and
generating control signals to selectively tune output frequency of a laser generating the laser beam in response to comparison of the measured electrical voltage and the desired threshold voltage so that striation pattern generation in the workpiece during laser cutting is minimized.

2. The method for minimizing formation of striation patterns in laser cutting as recited in claim 1, wherein the comparison of the measured electrical voltage with the desired threshold voltage includes calculation of a difference between a root mean square of a measured electrical voltage signal and a desired threshold root mean square value.

3. The method for minimizing formation of striation patterns in laser cutting as recited in claim 2, wherein the step of generating control signals to selectively tune output frequency of the laser includes generation of control signals to selectively tune the output frequency of the laser so that the difference between the root mean square of the measured electrical voltage signal and the desired threshold root mean square value is minimized.

4. A method for minimizing formation of striation patterns in laser cutting, comprising the steps of:
generating a laser beam;
focusing the laser beam onto a surface of a workpiece;
positioning an optical probe adjacent a focal point of the laser beam on the workpiece being cut by the laser beam;
measuring electrical voltage generated in the optical probe by thermal radiation generated during the cutting of the workpiece by the laser beam;
comparing the measured electrical voltage with a desired threshold voltage; and
generating control signals to selectively tune output frequency of a laser generating the laser beam in response to comparison of the measured electrical voltage and the desired threshold voltage so that striation pattern generation is minimized.

5. The method for minimizing formation of striation patterns in laser cutting as recited in claim 4, wherein the comparison of the measured electrical voltage with the desired threshold voltage includes calculation of a difference between a root mean square of a measured electrical voltage signal and a desired threshold root mean square value.

6. The method for minimizing formation of striation patterns in laser cutting as recited in claim 5, wherein the step of generating control signals to selectively tune output frequency of the laser includes generation of control signals to selectively tune the output frequency of the laser so that the difference between the root mean square of the measured electrical voltage signal and the desired threshold root mean square value is minimized

7. A system for minimizing formation of striation patterns in laser cutting, comprising:
an optical probe adapted for being selectively positioned adjacent a focal point of a laser cutting beam onto a workpiece being cut;
means for measuring electrical voltage generated in the optical probe by thermal radiation generated during the cutting of the workpiece by the laser beam;
means for comparing the measured electrical voltage with a desired threshold voltage; and
means for generating control signals to selectively tune laser beam frequency of the laser in response to comparison of the measured electrical voltage and the desired threshold voltage so that striation pattern generation is minimized.

8. The system for minimizing formation of striation patterns in laser cutting as recited in claim 7, further comprising means for calculating a root mean square of the measured electrical voltage signal.

9. The system for minimizing formation of striation patterns in laser cutting as recited in claim 8, further comprising means for calculating a difference between the root mean square of the measured electrical voltage signal and a desired threshold root mean square value.

10. The system for minimizing formation of striation patterns in laser cutting as recited in claim 9, wherein said means for generating control signals to selectively tune laser beam frequency comprises means for means for tuning the laser beam frequency so that the difference between the root mean square of the measured electrical voltage signal and the desired threshold root mean square value is minimized.
